(19) United States
(12) Patent Application Publication
(10) Pub. No.: US 2004/0267714 A1
(43) Pub. Date: Dec. 30, 2004

(54) Method and system for computerized creating, maintaining, updating, and querying inventory database over the internet for the locations and the obiects with time-dependent and time-independent attributes

(76) Inventors: Yuri Frid, New York, NY (US); Boris Stavrovski, New York, NY (US)

Correspondence Address: Yuri Frid, Freed of Downtown Property, 5th Floor., 45 West 21st Street,, New York, NY, 10010, US

(21) Appl. No.: 10/606,416

(22) Filed: Jun. 27, 2003

(51) Int. Cl. G06F 17/00

(52) U.S. Cl. 707/3

(57) ABSTRACT

A method and a system for computerized creating, maintaining, updating, and querying inventory database for the locations and the objects with time-dependent and time-independent attributes that presumes the evaluation of actual preferences for the customers (users, owners of the inventory) on the basis of interactive contacts with them over the Internet, supplying the customer with the necessary software tools for querying the said inventory database and for requesting the irregular out-of-schedule updates, creation lists of locations and locations' attributes, lists of objects and objects' attributes, generation the particular values for objects' controllable inventorial time-dependent and time-independent attributes, registration of particular values for said locations' and objects' attributes, thus creating current sections of inventory database, transmission the said sections into central data warehouse, determination of regular updating periodicity, implementation of regular and irregular updates, and prompt response for other customers' queries.

### BACKGROUND OF THE INVENTION

This invention relates to a method and a computerized system for creating and maintaining over the Internet the inventory-databases, specially designed in a manner suitable for multiple regular and irregular updates of the substantially dynamic parameters.

In particular, it relates to a method and a system for computerized creating, maintaining, updating, and querying inventory database for the locations and the objects with time-dependent and time-independent attributes that presumes the evaluation of actual preferences for the customers (users, owners of the inventory) on the basis of interactive contacts with them over the Internet, supplying the customer with the necessary software tools for querying the said inventory database and for requesting the irregular out-of-schedule updates, creation lists of locations and locations' attributes, lists of objects and objects' attributes, generation of the particular values for objects' controllable inventorial time-dependent and time-independent attributes, registration of particular values for said locations' and objects' attributes, thus creating current sections of inventory database, transmission the said sections into central data warehouse, determination of regular updating periodicity, implementation of regular and irregular updates, and prompt response for other customers' queries.

The development of electronic commerce utilizing the numerous publicly available databases has greatly expanded the extent of products and services that can be accessed effectively via the Internet. These range from simple items that are easily described by several main features (Le., books, airplane tickets, cars, etc.) to more complicated, less standardized products (i.e., real estate, medical legal and financial services).

Creation and maintaining of multidimensional inventory databases for objects with complex dynamic attributes is a perfect example of the second products' class.

The complexity of successful electronic transaction for such cases originates from several sources, such as:

complexity of the product in question (i.e., inventory database for multiple different types of locations with multiple different types of the objects, where each of the locations and of the objects has complex dynamic structure of relevant attributes);

complexity of the service in question (Le., processes of creating, maintaining, updating, and querying the dynamic inventory database);

complexity and interdependence of the customer's preferences (which cannot be usually described in a single measure i.e. money) above the possible multiple values for all parameters, describing the product and the service.

With the goal to illustrate first of the sources of complexity mentioned above, some examples of relevant attributes with complex dynamic structure are placed in Tables 1 and 2.

TABLE 1
Examples of the relevant locations' attributes to be included
into an inventory database

| ATTRIBUTES | Controllable | Uncontrollable |
|---|---|---|
| Time- | Name | Kind (room, building, truck, ship, etc.) |
| Independent | Code in | Initial and final(if different) addresses |
| | inventory | (positions) |
| | Documentation | Phone and fax numbers, e-mail address |
| | to be | Name of the contact person |
| | kept (if any) | Main parameters of the space (floor |
| | | plan etc) |
| | | Rules, regulations, and special |
| | | requirements to be satisfied (if any) |
| Time- | Route and | Current position (for a moving |
| Dependent | regimes of | location) |
| | movement | Duration of movement |
| | (if any) | Outside weather and traffic conditions |
| | Inside | |
| | climatic | |
| | conditions | |

TABLE 2
Examples of the relevant objects' attributes to be included
into an inventory database

| ATTRIBUTES | Controllable | Uncontrollable |
|---|---|---|
| Time- | Name | Kind (furniture, equipment, |
| Independent | Code in inventory | plants, food products, |
| | Boxing (package) | animals, etc.) |
| | Documentation to be | Sizes and weight |
| | kept (if any) | Shape and color |
| | | Date of entry (delivery) |
| | | Price paid |
| | | Rules, regulations, and special |
| | | requirements to be |
| | | satisfied (if any) |
| Time- | Position in space at the | Physical and chemical |
| Dependent | location | structure and composure |
| | Number of identical | Current condition |
| | objects in inventory | Age and ageing pattern |
| | Ability to be used | (freshness etc.) |
| | Buying and selling | Available terms of replacement |
| | prices wishful for | Buying and selling prices |
| | identical objects | available for identical objects |
| | | Tax consequences (if any) |

The types of objects, for which the attributes shown in Table 2 could be relevant, are pretty obvious—different kinds of equipment, food and drug products, animals and plants, furniture etc. Nevertheless, there are examples of less obvious use for the same ideology of dynamic inventory database—like transportation of convicts (where the inventory should be thoroughly checked at least twice: at the starting point and at the destination point) or just the routine travel of pupils in a school bus. It is clear that in both last cases the location's attributes are becoming dynamic as well as the objects' attributes.

There are several prior art approaches with attempts to help participants in eliminating or at least diminishing some of the problems connected with this process.

For instance, U.S. Pat. No. 6,418,441 deals mostly with Internet-connected features of the complex databases and describes methods and apparatus for disseminating over the Internet product information produced and maintained by product manufacturers using existing universal product codes (bar codes) as access keys. A cross-referencing resource, which may take the form of an independent HTTP server, an LDAP directory server, or the existing Internet Domain Name Service (DNS), receives Internet request messages containing all or part of a universal product code and returns the Internet address at which information about the identified product, or the manufacturer of that product, may be obtained. By using preferred Web data storage formats which conform to XML, XLS, XLink, Xpointer and RDF specifications, product information may be seamlessly integrated with information from other sources. A “web register” module can be employed to provide an Internet interface between a shared sales Internet server and an otherwise conventional inventory control system, and operates in conjunction with the cross-referencing server to provide detailed product information to Internet shoppers who may purchase goods from existing stores via the Internet.

However the problem of maintaining the complex dynamic structure of the object's attributes is left untouched in that prior art approach.

The method and apparatus described in U.S. Pat. No. 6,401,091 relates to a business information repository system that is coupled to a distributed network. The business information repository system includes a user interface that is coupled to a control system. The control system accesses a business information database using a search engine. The business information database includes business information including glossaries, graphics, resumes, skills inventories, citations, proposals, customer information and internal corporate profiles, vendor information, standard solutions, and forecasted deal information.

Although the structure of the proposed database is rather complicated here, once again there are no recommendations how to deal with time-dependent attributes of the objects.

One more attempt to deal with those problems is done in U.S. Pat. No. 6,403,419, describing a database multipoint synchronization, which allows multiple clients to simultaneously access and edit a database while avoiding inadvertent data corruption and ensuring the integrity of data within the database. A database manager, which may be configured as part of a database software application, keeps track of modifications saved to a database file and increments a modification change counter accordingly. When a client user accesses a database record, the database manager detects the modification change counter value. Then if that client seeks to save modifications to the database record, the database manager detects the current modification change counter value to discern whether other clients have saved modifications to the record following the access by the client presently seeking to save modifications. If the modification change counter has incremented, the client is denied authorization to save the modifications and offered a choice of alternative operations. In this way, the data within the database record is not corrupted due to inadvertently overwriting by another client's record.

As it is clear from the description above, this prior art approach is dealing more with the problem of simultaneous use of the database by several clients, than with dynamical features of the object's attributes itself.

Finally, the prior art approach described in U.S. Pat. No. 6,376,930 relates to a computerized process of intelligently inventorying data and managing assets and includes the steps of initially inventorying a plurality of hardware, software, and data files on-site by assigning a hexadecimal signature identifying each file in the database, inventorying the files at a subsequent time by repeating the prior step and comparing the previous and current signatures of the files to determine whether any of the files have been changed, comparing the current version of a changed file to the last previous on-site version of the changed file, computing the differences between the two versions by different forward and reverse algorithms to provide a forward delta and a reverse delta, storing the current version and the reverse delta of the changed file on-site while deleting the last previous on-site version of the changed file, permanently storing off-site the forward deltas of each changed file and a baseline copy of each new file, restoring any requested file, if on-site, by recovering the current version and subtracting the appropriate reverse deltas there from until the requested file is produced, or, if off-site, by recovering the baseline version and adding the appropriate forward deltas thereto until the requested file is reproduced. The inventorying process enables the system to issue warnings for deleted files, possible corruption of files, and unidentified possibly valued asset files.

Here, the step-by-step dynamics of the database functioning is described in a rather detailed manner, but still is not defined by the specifics of the inner dynamic behavior of the objects' attributes itself.

While facilitating some over-the-Internet database related transactions, these and other prior art methods and systems [see References below/above] suffer from many disadvantages and drawbacks. In particular, neither of prior art approaches is capable of helping to offer a solution to the complexity related problems Further, any one of the prior art documents, related to the transaction in question, does not deal with it as with the whole integrated process—as it in fact is. Recurrent repetitions of the previous process steps because of necessity of regular and/or irregular updates are one of the most characteristic and complex features of the process as a whole.

### BRIEF SUMMARY OF THE INVENTION

It is an object of this invention to overcome the aforementioned limitations of the prior art. It is another object of the invention to provide ready access over the Internet for creating and maintaining the inventory databases, specially designed in a manner suitable for multiple regular and irregular updates of the substantially dynamic parameters.

In particular, it is an object of the invention to provide a method and a system for constructing and exploiting inventory database over the Internet for the locations and the objects with dynamic attributes, comprising the steps of

the evaluation of actual preferences for the customers (users, owners of the inventory) on the basis of interactive contacts with them over the Internet,

supplying the customer with the necessary software tools for querying the said inventory database and for requesting the irregular out-of-schedule updates,

creation lists of locations and locations' attributes, lists of objects and objects' attributes,

generation the particular values for objects' controllable inventorial time-dependent and time-independent attributes,

registration of particular values for said locations' and objects' attributes, thus creating current sections of inventory database,

transmission the said sections into central data warehouse,

determination of regular updating periodicity,

implementation of regular and irregular updates,

prompt response for other customers' queries.

These objects and others are achieved through a method and a system for implementing a business transaction over the Internet with use and consecutive transformation of information from publicly available databases, wherein the system:

on the basis of interactive contacts with the potential customers (users, owners of the inventory) creates:

i) the initial lists of locations and locations' attributes to be included into the projected inventory database;

ii) the initial lists of objects and objects' time-dependent and time-independent controllable and uncontrollable attributes to be included into the projected inventory database for each of said locations;

iii) the evaluation of actual preferences for the customers (users) on the set of possible ageing manners for projected inventory database content;

registers the particular values for said locations' attributes to be included into the said inventory database thus creating the files of said attributes for said locations;

generates the particular initial values for objects' controllable inventorial time-dependent and time-independent attributes for each or of said locations;

registers the said generated particular initial values for said objects' controllable inventorial time-dependent and time-independent attributes altogether with initial values for others objects' uncontrollable time-dependent and time-independent attributes for each of said locations thus creating the files of said objects' attributes for said locations;

transmits the said files of locations' attributes, the said registered particular initial values for said objects' controllable inventorial time-dependent and time-independent attributes altogether with initial values for said others objects' uncontrollable time-dependent and time-independent attributes for each or of said locations into the central data warehouse over the Internet;

creates the initial section of inventory database at the said central data warehouse and sending the initial report to the user (owner of the inventory) over the Internet;

on the basis of actual user's preferences on the set of possible ageing manners for said inventory database content predetermines regular updating periodicity Δtu (time intervals between regular updates), thus defining the time schedule for the regular database's update;

after the said predetermined time interval Δtu has elapsed:

i) recurrently returns to the previous steps;

ii) implements the updating changes of the said files of said locations' attributes, of the said initial values for said objects' controllable inventorial time-dependent attributes altogether with the updating changes of said initial values for said others objects' uncontrollable time-dependent attributes for each of said locations;

iii) sends the current report to the user (owner of the inventory) over the Internet;

supplies the customer (the owner of the inventory) with the necessary software tools, including passwords, to implement over the Internet the whole range of the available user's operations, including but not limiting with:

i) querying the said current inventory database;

ii) requesting the irregular out-of-schedule update of the said current inventory database if stable connection over the Internet is available;

iii) changing the current lists of said locations and/or locations' attributes if said changes are available for the customer, or filing over the Internet the request for these said changes to be implemented by the said central data warehouse;

iv) changing the current lists of said objects and/or objects' time-dependent and/or time-independent controllable and/or uncontrollable attributes for each or some of said locations if said changes are available for the customer, or filing over the Internet the request for these said changes to be implemented by the said central data warehouse;

v) updating the current files of said locations' attributes or filing over the Internet the request for said update to be implemented by the said central data warehouse;

vi) changing the current description of the customer's preferences if said changes are available for the customer, or filing over the Internet the request for these said changes to be implemented by the said central data warehouse;

vii) changing the current values for said objects' controllable inventorial time-dependent and/or time-independent attributes altogether with current values for some of or for all others objects' uncontrollable time-dependent and/or time-independent attributes for each or for some of said locations if said changes are available for the customer, or filing over the Internet the request for these said changes to be implemented by the said central data warehouse;

in the case when incoming query does not require the irregular update or stable connection over the Internet is unavailable, querying the current section of inventory database and sending to the customer a report, representing a prompt response to the customer's request;

in the case when incoming query requires the irregular update, recurrent return to the previous steps and implementing:

i) the required changes of said current lists of said locations and/or locations' attributes;

ii) the required changes of said current lists of said objects and/or objects' time-dependent and/or time-independent controllable and/or uncontrollable attributes for some or for all of said locations;

iii) the required changes of said current files of said locations' attributes;

iv) the required changes of said current description of the customer's preferences;

v) the required changes of said current values for said objects' controllable inventorial time-dependent attributes altogether with the required changes for some of or for all of said current values for said others objects' uncontrollable time-dependent attributes for each or for some of said locations;

sends over the Internet to the user (owner of the inventory) the confirmation, reporting the changes made according to the user's requests at the previous step.

According to one aspect of the invention, the system

generates the bar-code identification labels as initial values for objects' controllable inventorial time-independent attributes (primary keys) and placing these labels at the visually accessible surfaces of the said objects;

creates digital photo- and/or video-images as initial values for the objects' controllable inventorial time-dependent attributes in a way, that guarantees positioning of the said labels in a field of the said images;

registers the particular initial values for objects' controllable inventorial time-dependent and time-independent attributes on the basis of digital decoding of said photo- and/or video-images.

According to another aspect of the invention, the system defines the time Tn for the database update number “n” as a function of the data base parameters P(Tn−1), which have been determined at the previous update number “n−1”, and/or decision making strategy including but not limiting with the next:

i) presuming permanence of the database parameters

P(Tn)=P(Tn−1)=const

ii) using calculated approximations for P(Tn) as a function F of all previous history of database parameters' values

P(Tn)=F{P(Ti), iε(0,n)}

iii) calculating the time interval Δtun, Tn=Tn−1+Δtun, by resolving an optimization problem:

Δtun=ArgMaxUc(Δtun), ∀Δtunε(Δtumin,Δtumax),

where

Uc stands for the customer's utility function,

Δtumin stands for the minimal interval between two updates, which is technically possible,

Δtumax stands for the maximal interval between two updates, which is determined reasonable by the customer;

iv) using a mixed strategy on the set of strategies i)-iii), when for one part of the database parameters strategy i) is implemented, for the other part of the database parameters strategy ii) is implemented, and for the last part of the database parameters strategy iii) is implemented.

### BRIEF DESCRIPTION OF SEVERAL VIEWS OF THE DRAWING

The objects, features, and advantages of the present invention will become more apparent from the following detailed description of a preferred embodiment thereof, taken in conjunction with the accompanying drawings, in which:

FIG. 1 is a block diagram of a system according to the invention;

FIGS. 2A and 2B are two portions of a flow chart illustrating the method of the preferred embodiment;

FIG. 3A-E illustrates five sequential steps of interactive elaboration of the customer's utility function U(X1,X2), where on the plane (X1,X2) of the object's parameters the object “i” with parameters (X1i,X2i) is shown first (FIG. 3A); then the recipient should choose the equally preferential object “j” with parameters (X1j, X2j) by simply positioning the point X2j on the direct line X1=X1j (FIG. 3B); connecting two points (X1i,X2i) and (X1j,X2j) we already may have the line of indifference for linear function U(X1,X2), where U(X1,X2)=const. (FIG. 3C); in the case of nonlinear U(X1,X2) we should proceed the same way with the third point U(X1k, X2k)—thus obtaining the nonlinear curve of indifference (FIG. 3D); repeating the procedure several times we obtain the family of such curves shown on FIG. 3E.

### DETAILED DESCRIPTION OF THE INVENTION

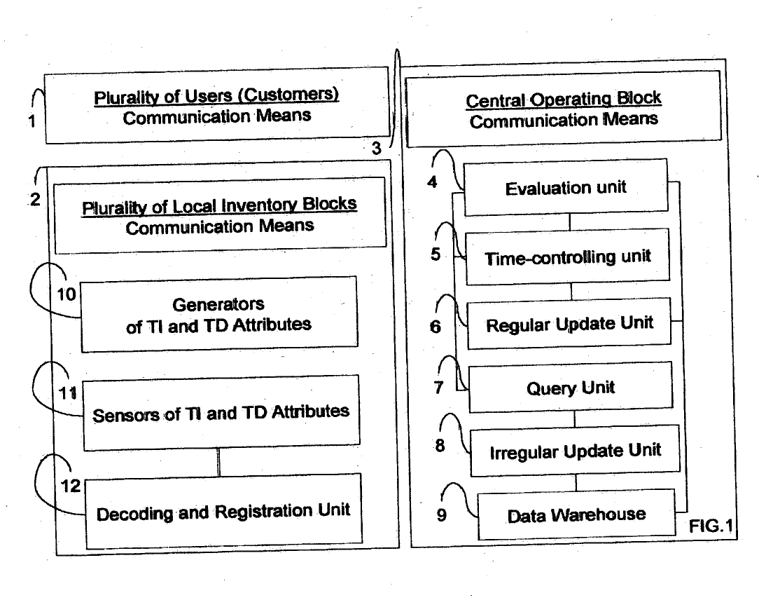

Turning now to a detailed consideration of a preferred embodiment of the present invention, FIG. 1 illustrates a greatly simplified block diagram of the primary elements of the computer-based system, which is employed for carrying out the method of the present invention.

The computer-based system includes a plurality of potential users' (customers') computer terminals 1 with its communication means (i.e., modem and phone line with possibilities to be connected with other parts of the system through the Internet), a plurality of local inventory blocks 2 with its communication means, and a central operating block 3 with its communication means, whose activities are designated for combining the system to function as a whole creation rather than a simple collection of the independent elements.

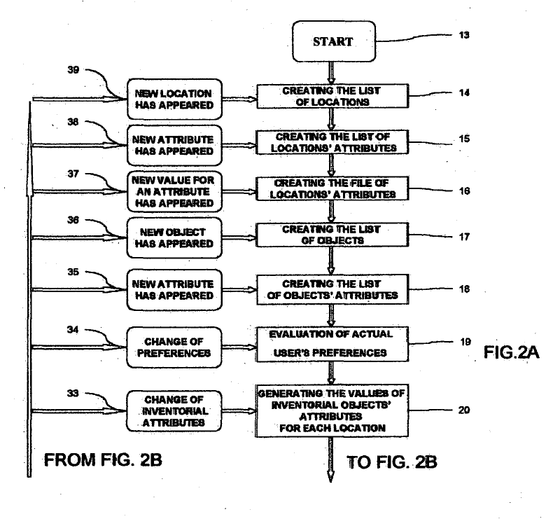

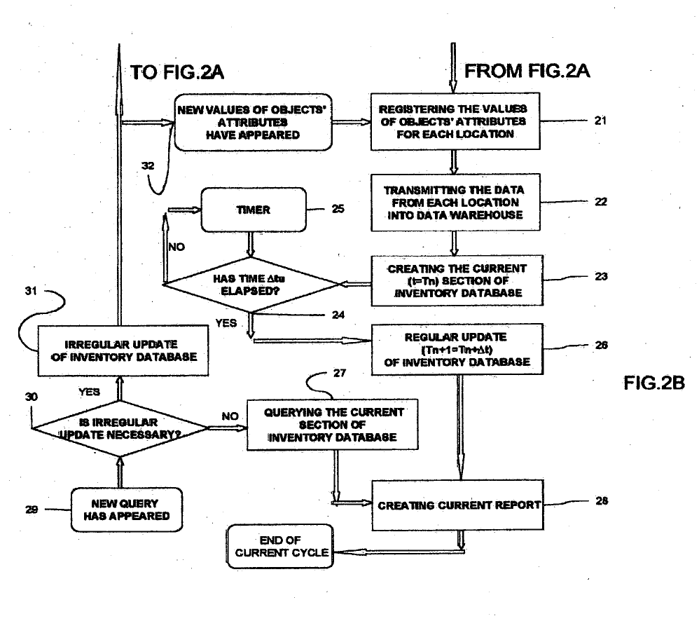

The mission of the whole system may be described as the consequence of steps illustrated on the simplified flowchart of the preferred embodiment in FIG. 2A and FIG. 2B:

after establishing the initial interactive contact with the potential customers 1 through the communication means over the Internet (position 13 at FIG. 2A) system creates

i) the initial lists of locations and locations' attributes to be included into the projected inventory database,

ii) the initial file of locations' attributes;

iii) the initial lists of objects and objects' time-dependent and time-independent controllable and uncontrollable attributes to be included into the projected inventory database for each of said locations,

iv) the evaluation of actual preferences for the customers (users) on the set of possible ageing manners for projected inventory database content

(being the part of the central operating block 3, as it is shown in FIG. 1, the evaluation unit 4 is programmed to fulfill these operations as described in detail below)—positions 14-19 in FIG. 2A;

system contacts through the communication means over the Internet plurality of local inventory blocks 2 disseminating the instructions to:

i) generate the particular initial values for objects' controllable inventorial time-dependent and time-independent attributes for each or of said locations (being the part of local inventory blocks 2, as it is shown in FIG. 1, the generators 10 of controllable inventorial time-dependent and time-independent attributes are programmed to fulfill these operations as described in detail below)—position 20 in FIG. 2A;

ii) register the said generated particular initial values for said objects' controllable inventorial time-dependent and time-independent attributes altogether with initial values for others objects' uncontrollable time-dependent and time-independent attributes for each of said locations thus creating the files of said objects' attributes for said locations (being the parts of local inventory blocks 2, as it is shown in FIG. 1, the sensors 11 of time-dependent and time-independent attributes altogether with decoding and registration unit 12 are programmed to fulfill these operations as described in detail below)—position 21 in FIG. 2B;

iii) transmit the said files of locations' attributes, the said registered particular initial values for said objects' controllable inventorial time-dependent and time-independent attributes altogether initial values for said others objects' uncontrollable time-dependent and time-independent attributes for each of said locations into the central data warehouse 9 over the Internet through the communication means of the local inventory blocks 2 (being the part of local inventory blocks 2, as it is shown in FIG. 1, decoding and registration units 12 are programmed to fulfill these operations as described in detail below)—position 22 in FIG. 2B;

system creates the initial section of inventory database at the said central data warehouse 9 and sends the initial report to the user (owner of the inventory) over the Internet (being the part of the central operating block 3, as it is shown in FIG. 1, the central data warehouse 9 is programmed to fulfill these operations as described in detail below)—position 23 in FIG. 2B;

on the basis of actual user's preferences on the set of possible ageing manners for said inventory database content system:

i) predetermines regular updating periodicity Δtu (time intervals between regular updates), thus defining the time schedule for the regular database's update (being the part of the central operating block 3, as it is shown in FIG. 1, the time-controlling unit 5 is programmed to fulfill these operations as described in detail below—positions 24-25 in FIG. 2B);

ii) implements the updating changes of the said files of said locations' attributes, of the said initial values for said objects' controllable inventorial time-dependent attributes altogether with the updating changes of said initial values for said others objects' uncontrollable time-dependent attributes for each of said locations and sends the current report to the user (owner of the inventory) over the Internet (being the part of the central operating block 3, as it is shown in FIG. 1, the regular update unit 6 is programmed to fulfill these operations as described in detail below—position 26 in FIG. 2B);

system supplies the customer (the owner of the inventory) with the necessary software tools, including passwords, to implement over the Internet the whole range of the available user's operations, including but not limiting with:

i) querying the said current inventory database;

ii) requesting the irregular out-of-schedule update of the said current inventory database;

iii) changing the current lists of said locations and/or locations' attributes if said changes are available for the customer, or filing over the Internet the request for these said changes to be implemented by the said central data warehouse;

iv) changing the current lists of said objects and/or objects' time-dependent and/or time-independent controllable and/or uncontrollable attributes for each or some of said locations if said changes are available for the customer, or filing over the Internet the request for these said changes to be implemented by the said central data warehouse;

v) updating the current files of said locations' attributes or filing over the Internet the request for said update to be implemented by the said central data warehouse;

vi) changing the current description of the customer's preferences if said changes are available for the customer, or filing over the Internet the request for these said changes to be implemented by the said evaluation unit of the said central operating block;

vii) changing the current values for said objects' controllable inventorial time-dependent and/or time-independent attributes altogether with current values for some of or for all others objects' uncontrollable time-dependent and/or time-independent attributes for each or for some of said locations if said changes are available for the customer, or filing over the Internet the request for these said changes to be implemented by the said central data warehouse

(being the part of the central operating block 3, as it is shown in FIG. 1, the query unit 7 is programmed to fulfill these operations as described in detail below);

being instructed by the customer over the Internet through its communication means, system defines the necessity in implementing the irregular update (being the part of the central operating block 3, as it is shown in FIG. 1, the irregular update unit 8 is programmed to fulfill this operation as described in detail below—positions 29-30 in FIG. 2B);

if irregular update is not necessary, system is querying the current section of inventory database and is sending to the customer over the Internet a report, representing a prompt response to the customer's request (being the part of the central operating block 3, as it is shown in FIG. 1, the query unit 7 is programmed to fulfill these operations as described in detail below—positions 27-28 in FIG. 2B);

if irregular update is necessary system implements:

i) the required changes of said current lists of said locations and/or locations' attributes—positions 39-40 in FIG. 2A;

ii) the required changes of said current files of said locations' attributes—position 38 in FIG. 2A;

iii) the required changes of said current lists of said objects and/or objects' time-dependent and/or time-independent controllable and/or uncontrollable attributes for some or for all of said locations—positions 36-37 in FIG. 2A;

iv) the required changes of said customer's preferences position 35 in FIG. 2A;

v) the required changes of said current values for said objects' controllable inventorial time-dependent attributes altogether with the required changes for some of or for all of said current values for said others objects' uncontrollable time-dependent attributes—for each or for some of said locations—positions 34 in FIG. 2A and 33 in FIG. 2B;

vi) sending over the Internet to the user (owner of the inventory) the confirmation, reporting the changes made according to the user's requests

(being the part of the central operating block 3, as it is shown in FIG. 1, the irregular update unit 8 is programmed to fulfill these operations as described in detail below—positions 32-33 in FIG. 2B, 34-40 in FIG. 2A).

Having in mind completely the described process, it is now possible to define the details and the variants of the procedure for the each specific step.

After a preliminary contact with the potential customer have been initiated, the system has to establish the lists of main attributes for a projected inventory database. There should be at least two such lists: a list of locations' attributes and a list of objects' attributes.

A list of locations' attributes should include at least: the name of the location, the address of the location, phone and fax numbers, the e-mail address, the name of the contact person responsible for cooperation in creation and maintaining an inventory database at that location, the type of the building (storage), main parameters of the building etc. In a case when an inventory database should be created in only one location (or in small number of locations), the particular values of the location's attributes may be registered simultaneously with the creation of that list—thus generating the initial file of locations' attributes.

In some of applications that are more complicated, the locations' attributes could constitute the dynamic objects by itself This is true, for example, in case of moving locations—trucks, ships, planes etc. Here such attributes as route and regimes of movement, its duration, inside and outside climatic conditions, traffic limitations etc. should be included into consideration. In those more complicated cases, the creation and consequent updates of the initial file of locations' attributes should be implemented in accordance with the algorithm described here for the file of the objects' attributes.

In accordance with the preferred embodiment the list of objects' attributes should be divided into two parts: time-independent attributes and time-dependent attributes. First part of the attributes' values (time-independent) should be registered just once—at the phase of the inventory database initial creation. Second part of the attributes' values (time-dependent) should be updated under the procedures of all consecutive regular and irregular updates of the inventory database. The examples of time-independent attributes are including at least: kinds (types) and names of objects to be included into the inventory database, sizes and weights of those objects (could be time-dependent as well—for plants, animals etc.), their dates of entry into inventory (delivery) and prices paid. The examples of time-dependent attributes are including at least: physical and chemical structure and composure (could be time-independent as well), age and ageing pattern (freshness etc.), available terms of replacement, selling price available for identical objects etc.

The other division of the objects' attributes could be done by differentiation of controllable and uncontrollable attributes. All objects' attributes named so far are the examples of the uncontrolled attributes. The examples of controllable attributes are including at least: code in inventory, boxing (package), documentation to be kept (if any), position in space, number of identical objects in inventory, ability to be used, buying and selling prices wishful for identical objects etc. Here three first attributes mentioned are time-independent, and all others are time-dependent.

Some of controllable attributes (like a code in inventory, a position in space etc.) alongside with some locations' attributes are constituting the part of the lesser group of the inventory attributes.

The initial lists of the objects' attributes should be created as a result of the interactive contacts with the customer for each particular location separately, because there is no reason to presume the oneness of those lists for different locations.

The process of creating the initial section of an inventory database includes four major steps:

generating the particular initial values for objects' controllable inventorial time-dependent and time-independent attributes for each of said locations;

registering the generated particular initial values for objects' controllable inventorial time-dependent and time-independent attributes altogether with initial values for others objects' uncontrollable time-dependent and time-independent attributes for each of said locations thus creating the files of objects' attributes for said locations;

transmitting the files of locations' attributes, the registered particular initial values for objects' controllable inventorial time-dependent and time-independent attributes altogether with initial values for others objects' uncontrollable time-dependent and time-independent attributes for each or of said locations into the central data warehouse over the Internet;

creating the initial section of inventory database at the central data warehouse and sending the initial report to the user (owner of the inventory) over the Internet.

There are many traditional ways to generate the inventorial attributes for different kinds of objects—starting with simple stamping of inventory signs at some well visible point of the object's surface and finishing with differential radioactive coloration of the objects, thus creating individual ID attribute for each and every of them One of the most commonly used ways to create such an individual ID attribute involves generation of the bar-code identification labels as initial values for objects' controllable inventorial time-independent attributes (primary keys). The evident advantages of the bar-code identification labels are:

simplicity and cheapness of creation;

reliability and antijamming stability;

practically unlimited terms of service;

possibility to use unqualified personnel for generation and subsequent registration (updates).

At the same time at the context of dealing with the essentially dynamic objects, the bar-code identification labels are not specially adapted for simultaneous reading and registering alongside with others time-dependent attributes—like shape of the object, its position in space, current condition etc. With the goal to eliminate that particular drawback, we suggest:

to place these bar-code identification labels at the visually accessible surfaces of the said objects;

to create digital photo- and/or video-images as initial values for the objects' controllable inventorial time-dependent attributes (primary keys) in a way, that guarantees positioning of the said labels in a field of the said images;

to register the particular initial values for objects' controllable inventorial time-dependent and time-independent attributes on the basis of digital decoding of said photo- and/or video-images.

In previous years, when the algorithmical and technological basis of processing photo- and/or video-images have not been sophisticated enough, it was possible to implement the procedure described in the last three paragraphs as three different subsequent operations:

1. registering the bar-code labels by the conventional bar-code reader;

2. entering the data from the previous step as a primary key into the database entry with photo- and/or video-images;

3. processing the data from photo- and/or video-images afterwards.

Now there exists special software, which is capable to decode the data from the bar-code label directly from digital photo- and/or video-images. The commercially available device, the so called wide area bar code reader, have been described, for example, on http://pigtrail.uark.edu/info/historical_markers/barcode.html, the disclosure of which is incorporated herein by reference.

The essentially dynamic behavior of the time-dependent locations' and/or objects' attributes creates the problem of the rationally (or even optimally) organized time schedule of regular and irregular updates for the inventory database. The premises for the existence of the rational (optimal) time schedule of updates are:

different velocities and different patterns of ageing for different time-dependent locations' and/or objects' attributes;

essential expenses of time, labor, and, eventually, money for each update;

necessity for the customer (owner of the inventory) to be aware about all and any of substantial changes in values for relevant locations' and/or objects' attributes with the risks of potential losses involved both with the usage of out-of-date information and/or requesting too many updates of it with too big frequency.

It is usually impossible to describe the preferences of the customer on the set of possible updating schedules by using a one simple criterion—like expenses for an update or a risk of financial losses, connected with untimely updates. Therefore, we should look for some universal tools.

The theory and formal apparatus of quantitative evaluation of preferences for an individual is the subject of so-called utility theory. The main theoretical concepts of the utility theory have been described, for example, by Peter C. Fishburn in “Nonlinear Preference and Utility Theory”, The Johns Hopkins University Press, Baltimore, 1988, 259 pp., the disclosure of which is incorporated herein by reference.

The main formal tool of the theory—the utility function—mathematically describes the individual's preferences within the total scope of possible ways of resolution and of predictable results for problem in question. The utility theory has good, established, practical and reliable algorithms (simple in 1-2 dimensional case but facing growing problems in multidimensional one—in fact all more or less complicated methods of mathematical logical analysis has such problems) for generating utility functions' approximations with predetermined exactness of description for the individual's preferences.

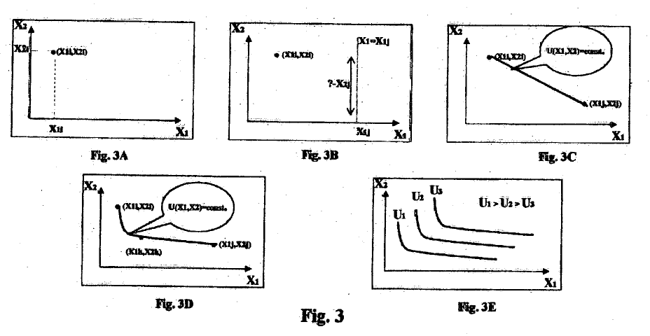

The idea of a such practical algorithm is fairly simple and may be illustrated with the sequence of drawings in FIG. 3, where on plane (X1,X2) of the problem's description parameters each particular point (X1i,X2i) represents the particular result “I” of the problem resolution—FIG. 3A.

The interactive procedure of the utility function elaboration starts with the next question to the recipient: “If in comparison with the result (X1i,X2i), you should choose the other result “j” with one already fixed component X1j (let's say to be definite that X1j>X1i)—how will you pick the second component X2j to achieve the result, which will be practically equal for you in its utility?” Geometrically (FIG. 3B) the recipient should place the point on the vertical line X1=X1j thus designating the second coordinate X2j of the point (X1j,X2j) with the same utility as the point (X1i,X2i) has for him.

When we are discussing the simplest case of linear indifference curve (the curve of indifference is connecting the results of equal utility for the recipient), we will obtain the only available variant of such curve in the form of a straight line, connecting two points (X1i,X2i) and (X1j,X2j)—FIG. 3C.

The hypothesis of linearity for indifference curve can be checked by asking the recipient to find the third point (X1k, X2k) which will be equivalent in its utility for any of the two points defined previously. If the point “k” will be found on the same straight indifference curve—the hypothesis is correct, adversely we should switch to nonlinear approximations of the indifference curve—this last case is illustrated in FIG. 3D.

As a result of such procedure we only have an approximation of the utility function, because any mathematical method used for its allocation can not guarantee that all other equivalent points will be exactly situated on the same indifference curve. However, in this case it is always possible to evaluate the potential errors of that approximation exactly. When we are not satisfied with these potential errors, the number of equivalent points in consideration should be simply enlarged thus making the quality of approximation better. Finally, we will be able to receive the approximation of the recipient's utility function in the compact form

U(X1,X2) (1)

with possibilities to determine its computational errors in each point and with the family of constant level curves (the indifference curves) shown in FIG. 3E.

The same step-by-step logic of comparison for pairs of the results should be used in multidimensional case. This procedure becomes even easier under a broadly used assumption that the utility function of a psychologically normal individual can be approximated with so-called logistic curve

U(X)=a+b*exp{−c*X}, (2)

where

a, b, c—stands for the constant coefficients;

X—stands for the scalar result of the problem's resolution.

In the case when the recipient's preferences can be described independently from each other, the global utility function in multidimensional space will constitute the simple superposition of the scalar (marginal) functions and its formal description will be the result of multiplication of these marginal functions:

U(X1,X2, . . . ,Xn)=U(X1)*U(X2)* . . . *U(Xn). (3)

Again, the validity of this assumption can be easily checked on the basis of additional questioning of the recipient.

In our particular case, the formula (2) can be rewritten in a form:

U(X)=a+b*exp{−c*(Δtu)}, ∀Δtuε(Δtumin,Δtumax), (4)

where

Δtumin stands for the minimal interval Δtu between two updates, which is technically possible;

Δtumax stands for the maximal interval Δtu between two updates, which is determined reasonable by the customer.

Further on, one possible rational solution for the problem of the optimal scheduling of the inventory database updates (in a case when regular updates are following each other in Δtu time units (days, months, years etc)) may be found from (4) as

Δtu=ArgMaxUc(Δtu),∀Δtu(Δtumin,Δtumax). (5)

Solution (5) is one of the most complicated possible solutions of the scheduling problem The simplest are:

presuming permanence for the database parameters P (or for some part of those parameters) between two consecutive updates of the database #(n−1) and #n

P(Tn)=P(Tn−1)=const, (6)

thus excluding necessity in an update #n at all;

using some methods of mathematical predictions for vector P(Tn) as a function F of all previous history of database parameters' values

P(Tn)=F{P(Ti),iε(0,n)}, (7)

thus excluding necessity in an update #n one more time.

It is clear that procedures (6)-(7) could be often used not for the whole vector P, but just for the part of its components, which has a less intensive dynamic behavior (for example, (6) is true by definition for all time-independent attributes).

It is also very important to mention here, that in real life the quality of a mobile Internet connection may be far from ideal and in some limited intervals of time this connection may not be available at all. For those cases, the usage of the procedures (6)-(7) may occur to be the only possibility available as a response for the new query. The availability of backup copies of current inventory database at all locations is a necessary condition for the system to stay functional in such situation.

One of the most useful conceptual tools in all cases of decision making in competitive environment (and maintaining of an inventory database is undoubtedly one of those examples—at least as a game with Nature) is the theory of games. It is mathematically proven fact of that theory that the usage of a mixed strategy (rational stochastic mix on the set of pure strategies) is consistently improving the possible outcomes of the optimization problem.

In our case using a mixed strategy on the set of strategies (5)-(7), when for one part of the database parameters strategy (5) is implemented, for the other part of the database parameters strategy (6) is implemented, and for the last part of the database parameters strategy (7) is implemented, may result in essential lowering of expenses on the database update.

After the timetable (schedule) of regular updates has been determined by the time-controlling unit of the proposed system, the same unit is taking responsibility for requesting the implementation of the next regular update #(n+1) after the time Δtu has elapsed from the moment Tn, when the previous regular update #n has taken place.

The routine maintenance of the existing inventory database thus will include regular implementations of the updating changes for the files of locations' and objects' attributes and regular deliveries of the updated reports to the user (owner of the inventory) over the Internet.

Additionally to these routine possibilities, the customer (the owner of the inventory) should be also capable at any moment of time to implement over the Internet the whole range of the available user's operations. The examples of those operations are:

querying the current inventory database;

requesting the irregular out-of-schedule update of the current inventory database;

changing (updating) the current lists(files) of locations (objects) and/or locations' (objects') attributes if these changes are available for the customer, or filing over the Internet the request for these changes to be implemented by the central data warehouse;

changing the current description of the customer's preferences if these changes are available for the customer, or filing over the Internet the request for these changes to be implemented by the evaluation unit of the central operating block.

The query unit of the central operating block further defines rather this particular request of the customer necessitates an irregular update of the inventory database or may be satisfied based on the information, which is routinely available. A reason for an irregular update may (or may not) be:

a new location (an object), or its attribute, or a value of an attribute has appeared;

a change of preferences has occurred.

If irregular update is found necessary, it is implemented by the irregular update unit of the central operating block (through the possible contact with a local inventory block in question) and the resulting report is delivered to the customer over the Internet after that. If the current information in the data warehouse is sufficient to satisfy the query, the only response of the inventory database includes the delivery of corresponding report to the customer over the Internet.

Although the present invention has been disclosed in terms of a preferred embodiment, it will be understood that numerous variations and modifications could be made thereto without departing from the scope of the invention as set forth in the following claims. For example, the use of the Internet as a communication media is not unique—the whole procedure may also be ascertained through the usual phone lines etc.

What is claimed is:

1. A computer-based method for creating, maintaining, updating, and querying inventory database over the Internet for the locations and the objects with time-dependent and time-independent attributes, comprising the steps of:
a) on the basis of interactive contacts with the potential customers (users, owners of the inventory) creating:
i) the initial lists of locations and locations' attributes to be included into the projected inventory database;
ii) the initial lists of objects and objects' time-dependent and time-independent controllable and uncontrollable attributes to be included into the projected inventory database for each of said locations;
iii) the evaluation of actual preferences for the customers (users) on the set of possible ageing manners for projected inventory database content;
b) registering the particular values for said locations' attributes to be included into the said inventory database thus creating the files of said attributes for said locations;
c) generating the particular initial values for objects' controllable inventorial time-dependent and time-independent attributes for each of said locations;
d) registering the said generated particular initial values for said objects' controllable inventorial time-dependent and time-independent attributes altogether with initial values for others objects' uncontrollable time-dependent and time-independent attributes for each of said locations thus creating the files of said objects' attributes for said locations;
e) transmitting the said files of locations' attributes, the said registered particular initial values for said objects' controllable inventorial time-dependent and time-independent attributes altogether with initial values for said others objects' uncontrollable time-dependent and time-independent attributes for each or of said locations into the central data warehouse over the Internet;
f) creating the initial section of inventory database at the said central data warehouse and sending the initial report to the user (owner of the inventory) over the Internet;
g) on the basis of actual user's preferences on the set of possible ageing manners for said inventory database content predetermining regular updating periodicity Δtu (time intervals between regular updates), thus defining the time schedule for the regular database's update;
h) after the said predetermined time interval Δtu has elapsed:
i) recurrent returning to the steps a)-g);
ii) implementing the updating changes of the said files of said locations' attributes, of the said initial values for said objects' controllable inventorial time-dependent attributes altogether with the updating changes of said initial values for said others objects' uncontrollable time-dependent attributes for each of said locations;
iii) sending the current report to the user (owner of the inventory) over the Internet;
i) supplying the customer (the owner of the inventory) with the necessary software tools, including passwords, to implement over the Internet the whole range of the available user's operations, including but not limiting with:
i) querying the said current inventory database;
ii) requesting the irregular out-of-schedule update of the said current inventory database;
iii) changing the current lists of said locations and/or locations' attributes if said changes are available for the customer, or filing over the Internet the request for these said changes to be implemented by the said central data warehouse;
iv) changing the current lists of said objects and/or objects' time-dependent and/or time-independent controllable and/or uncontrollable attributes for each or some of said locations if said changes are available for the customer, or filing over the Internet the request for these said changes to be implemented by the said central data warehouse;
v) updating the current files of said locations' attributes or filing over the Internet the request for said update to be implemented by the said central data warehouse;
vi) changing the current description of the customer's preferences if said changes are available for the customer, or filing over the Internet the request for these said changes to be implemented by the said central data warehouse;
vii) changing the current values for said objects' controllable inventorial time-dependent and/or time-independent attributes altogether with current values for some of or for all others objects' uncontrollable time-dependent and/or time-independent attributes for each or for some of said locations if said changes are available for the customer, or filing over the Internet the request for these said changes to be implemented by the said central data warehouse;
j) in the case when incoming query does not require the irregular update or stable connection over the Internet is unavailable, querying the current section of inventory database and sending to the customer a report, representing a prompt response to the customer's request;
k) in the case when incoming query requires the irregular update and stable connection over the Internet is available, recurrent return to the steps a)-g) and implementing:
i) the required changes of said current lists of said locations and/or locations' attributes;
ii) the required changes of said current lists of said objects and/or objects' time-dependent and/or time-independent controllable and/or uncontrollable attributes for some or for all of said locations;
iii) the required changes of said current files of said locations' attributes;
iv) the required changes of said current description of the customer's preferences;
v) the required changes of said current values for said objects' controllable inventorial time-dependent attributes altogether with the required changes for some of or for all of said current values for said others objects' uncontrollable time-dependent attributes for each or for some of said locations;
l) sending over the Internet to the user (owner of the inventory) the confirmation, reporting the changes made according to the user's requests at the step k).

2. The computer-based method of claim 1, wherein said steps of generating and registering the particular initial values for objects' controllable inventorial time-dependent and time-independent attributes further comprises:
a) generating the bar-code identification labels as initial values for objects' controllable inventorial time-independent attributes (primary keys) and placing these labels at the visually accessible surfaces of the said objects;
b) creating digital photo- and/or video-images as initial values for the objects' controllable inventorial time-dependent attributes in a way, that guarantees positioning of the said labels in a field of the said images;
c) registering the particular initial values for objects' controllable inventorial time-dependent and time-independent attributes on the basis of digital decoding of said photo- and/or video-images.

3. The computer-based method of claim 1, wherein said step of defining the time schedule for the regular database's update further comprises defining the time Tn for the database update number “n” as a function of the data base parameters P(Tn−1), which have been determined at the previous update number “n−1”, and/or decision making strategy including but not limiting with the next:
i) presuming permanence of the database parameters
P(Tn)=P(Tn−1)=const
ii) using calculated approximations for P(Tn) as a function F of all previous history of database parameters' values
P(Tn)=F{P(Ti),iε(0,n)}
iii) calculating the time interval Δtun, Tn=Tn−1+Δtun, by resolving an optimization problem:
Δtun=ArgMaxUc(Δtun),∀Δtunε(Δtumin,Δtumax),
where
Uc stands for the customer's utility function,
Δtumin stands for the minimal interval between two updates, which is technically possible,
Δtumax stands for the maximal interval between two updates, which is determined reasonable by the customer;
iv) using a mixed strategy on the set of strategies i)-iii), when for one part of the database parameters strategy i) is implemented, for the other part of the database parameters strategy ii) is implemented, and for the last part of the database parameters strategy iii) is implemented.

4. A computer-based system for creating, maintaining, updating, and querying inventory database over the internet for the locations and the objects with time-dependent and time-independent attributes, said system comprising:
a plurality of potential users' (customers') computer terminals with its communication means;
a central operating block with its communication means, said central operating block comprising:
a) an evaluation unit that is having possibilities through said communication means of said central operating block to contact interactively said potential users' (customers') computer terminals and is programmed for creating:
i) the initial lists of locations and locations' attributes to be included into the projected inventory database;
ii) the initial lists of objects and objects' time-dependent and time-independent controllable and uncontrollable attributes to be included into the projected inventory database for each of said locations;
iii) the evaluation of actual preferences for the customers (users) on the set of possible ageing manners for projected inventory database content;
b) a time-controlling unit, that is coupled to said evaluation unit, and is programmed for predetermining regular updating periodicity Δtu (time intervals between regular updates), thus defining the time schedule for the regular database's update, on the basis of actual user's preferences on the set of possible ageing manners for said inventory database content;
c) a regular update unit, that is coupled to said time-controlling unit, and is programmed under instructions of the said time-controlling unit:
i) to implement recurrently the updating changes of said values for said objects' controllable inventorial time-dependent attributes altogether with the updating changes of said values for said others objects' uncontrollable time-dependent attributes for each of said locations;
ii) to send the current report to the said user (owner of the inventory) over the Internet;
d) a query unit that is coupled to said evaluation and to said time-controlling units, and is programmed to supply the customer (the owner of the inventory) with the necessary software tools, including passwords, through the said communication means, to implement over the Internet the whole range of the available user's operations, including but not limiting with:
i) querying the said current inventory database;
ii) requesting the irregular out-of-schedule update of the said current inventory database;
iii) changing the current lists of said locations and/or locations' attributes if said changes are available for the customer, or filing over the Internet the request for these said changes to be implemented by the said central data warehouse;
iv) changing the current lists of said objects and/or objects' time-dependent and/or time-independent controllable and/or uncontrollable attributes for each or some of said locations if said changes are available for the customer, or filing over the Internet the request for these said changes to be implemented by the said central data warehouse;
v) updating the current files of said locations' attributes or filing over the Internet the request for said update to be implemented by the said central data warehouse;
vi) changing the current description of the customer's preferences if said changes are available for the customer, or filing over the Internet the request for these said changes to be implemented by the said central data warehouse;
vii) changing the current values for said objects' controllable inventorial time-dependent and/or time-independent attributes altogether with current values for some of or for all others objects' uncontrollable time-dependent and/or time-independent attributes for each or for some of said locations if said changes are available for the customer, or filing over the Internet the request for these said changes to be implemented by the said central data warehouse;
e) an irregular update unit, that is coupled to said query unit, and is programmed to implement under instructions of the said query unit:
i) the required changes of said current lists of said locations and/or locations' attributes;
ii) the required changes of said current lists of said objects and/or objects' time-dependent and/or time-independent controllable and/or uncontrollable attributes for some or for all of said locations;
iii) the required changes of said current files of said locations' attributes;
iv) the required changes of said current description of the customer's preferences;
v) the required changes of said current values for said objects' controllable inventorial time-dependent attributes altogether with the required changes for some of or for all of said current values for said others objects' uncontrollable time-dependent attributes for each or for some of said locations;
vi) sending over the Internet to the user (owner of the inventory) the confirmation, reporting the changes made according to the user's requests;
f) a data warehouse unit that is coupled to said evaluation, to said regular update, and to said irregular update units, and is programmed to create the initial and updated sections of inventory database and to send the reports to the user (owner of the inventory) over the Internet through the said communication means of the said central operating block;
a plurality of local inventory blocks with its movable computer terminals and communication means, said local inventory blocks comprising:
a) generators of time-dependent and time-independent controllable attributes that are programmed under instructions received from the said central operating block over said communication means
i) to generate the particular initial values for objects' controllable inventorial time-dependent and time-independent attributes;
ii) to generate regular updates of the said values in accordance with the schedule received from the said regular update unit of the said central operating block over said communication means;
iii) to generate irregular updates of the said values if such updates will be requested by the said irregular update unit of the said central operating block over said communication means and stable connection over the Internet is available;
b) sensors of time-dependent and time-independent controllable and uncontrollable attributes that are programmed under instructions received from the said central operating block over said communication means
i) to sensor initial and updated values of objects' controllable and uncontrollable inventorial time-dependent and time-independent attributes;
ii) to transmit said initial and updated values to a decoding and registration unit;
c) a decoding and registration unit that is coupled to said sensors and is programmed under instructions received from the said central operating block over said communication means
i) to register the particular values for said location's attributes to be included into the said inventory database thus creating the files of said attributes for said location
ii) to decode and register initial and updated values of objects' controllable and uncontrollable inventorial time-dependent and time-independent attributes thus creating the initial and updated files of said attributes for said locations;
iii) to transmit the said files of said location's attributes altogether with the said registered initial and updated values into the said central data warehouse of the said central operating block through the said communications means of the said local inventory block over the Internet.

5. The system according to claim 4, wherein:
a) said generators of time-independent and time-dependent controllable attributes are programmed for:
i) generating the bar-code identification labels as initial values for objects' controllable inventorial time-independent attributes (primary keys) and placing these labels at the visually accessible surfaces of the said objects;
ii) creating digital photo- and/or video-images as initial and updated values for the objects' controllable inventorial time-dependent attributes in a way, that guarantees positioning of the said labels in a field of the said images;
b) said decoding and registration unit of time-independent and time-dependent controllable attributes is programmed for registering the particular initial and updated values for objects' controllable inventorial time-dependent and time-independent attributes on the basis of digital decoding of said photo- and/or video-images.

6. The system according to claim 4, wherein said time-controlling unit is programmed for defining the time Tn for the database update number “n” as a function of the data base parameters P(Tn−1), which have been determined at the previous update number “n−1”, and/or decision making strategy including but not limiting with the next:
i) presuming permanence of the database parameters
P(Tn)=P(Tn−1)=const
ii) using calculated approximations for P(Tn) as a function F of all previous history of database parameters' values
P(Tn)=F{P(Ti),iε(0,n)}
iii) calculating the time interval Δtun, Tn=Tn−1+Δtun, by resolving an optimization problem:
Δtun=ArgMaxUc(Δtun),∀Δtunε(Δtumin,Δtumax),
where
Uc stands for the customer's utility function,
Δtumin stands for the minimal interval between two updates, which is technically possible,
Δtumax stands for the maximal interval between two updates, which is determined reasonable by the customer;
iv) using a mixed strategy on the set of strategies i)-iii), when for one part of the database parameters strategy i) is implemented, for the other part of the database parameters strategy ii) is implemented, and for the last part of the database parameters strategy iii) is implemented.
